(19) United States
(12) Patent Application Publication
(10) Pub. No.: US 2011/0135812 A1
(43) Pub. Date: Jun. 9, 2011

(54) METAL SEPARATOR FOR FUEL CELL AND METHOD FOR TREATING SURFACE OF THE SAME

(75) Inventors: Sae Hoon Kim, Gyeonggi-do (KR); Yoo Chang Yang, Gyeonggi-do (KR); Suk Min Baeck, Gyeonggi-do (KR); Seung Gyun Ahn, Gyeonggi-do (KR); Seung Eul Yoo, Seoul (KR); Young Mo Goo, Chungcheongnam-do (KR); Myong Hwan Kim, Chungcheongnam-do (KR)

(73) Assignees: Hyundai Motor Company, Seoul (KR); Kia Motors Corporation, Seoul (KR); Korea Automotive Technology Institute, Chungcheongnam-do (KR)

(21) Appl. No.: 12/880,413

(22) Filed: Sep. 13, 2010

(30) Foreign Application Priority Data
Dec. 4, 2009 (KR) 10-2009-0119465

(51) Int. Cl. B05D 5/12

(52) U.S. Cl. 427/115

(57) ABSTRACT

The present invention provides a metal separator for a fuel cell, which is surface-treated to have high electrical conductivity and electrochemical corrosion resistance, and a method for treating the surface of the same. The metal separator may include an amorphous carbon film formed on the surface of a separator substrate, the amorphous carbon film being carbonized by heat treatment to increase the proportion of sp². The surface treatment method may include: forming an amorphous carbon film on the surface of a separator substrate; and carbonizing the amorphous carbon film by heat treatment. Fuel cells having the metal separator can show excellent performance.

### CROSS-REFERENCE TO RELATED APPLICATION

This application claims under 35 U.S.C. §119(a) the benefit of Korean Patent Application No. 10-2009-0119465 filed Dec. 4, 2009, the entire contents of which are incorporated herein by reference.

### BACKGROUND

(a) Technical Field

The present disclosure relates to a metal separator for a fuel cell, which has high electrical conductivity and electrochemical corrosion resistance, and a method for treating the surface of the same.

(b) Background Art

Typically, a separator for a fuel cell stack serves to supply hydrogen and air or oxygen to an anode and a cathode, support a membrane electrode assembly (MEA) and a gas diffusion layer (GDL), transmit electrons generated at the anode to the cathode, and remove heat and water produced due to the generation of electricity.

The separator should meet certain requirements. It should possess, for example, excellent electrical and thermal conductivity, superior chemical properties, and low hydrogen permeability. One of the separators that were proposed is a metal separator. The metal separator, typically, is manufactured by processing a metal alloy in the form of a metal sheet or metal foam and treating the surface of the metal alloy with palladium (Pd), gold (Au), chromium nitride (CrN), titanium nitride (TiN) coated metal, etc.

The metal separator, however, has a problem that metal ions can be released due to electrochemical corrosion. Released metal ions contaminate the MEA to reduce the ion conductivity and cause the formation of oxides in the GDL to prevent gas from permeating through an electrode, thus reducing the performance of the fuel cell. Moreover, a non-conductive passivation film may be formed on the surface of the metal separator to increase the contact resistance between the separator and the GDL, which may negatively affect the performance of the fuel cell.

One of the methods that were proposed was to treat the surface of the metal separator to ensure high corrosion resistance and prevent the formation of an oxide film. A typically used surface treatment method was to nitride the surface (using Cr—TiN or CrN). However, the nitriding method still does not provide a satisfactory durability.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a metal separator for a fuel cell, the metal separator including an amorphous carbon film formed on the surface of a separator substrate, the amorphous carbon film being carbonized by heat treatment to increase the proportion of sp², which allows the amorphous carbon film to have electrical conductivity.

In another aspect, the present invention provides a method for treating the surface of a metal separator for a fuel cell, the method including: forming an amorphous carbon film on the surface of a separator substrate; and carbonizing the amorphous carbon film by heat treatment to increase the proportion of sp², which allows the amorphous carbon film to have electrical conductivity.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other aspects and features of the invention are discussed infra.

### BRIEF DESCRIPTION OF THE DRAWINGS

The above and other aspects and features of the present invention will now be described in detail with reference to certain exemplary embodiments thereof illustrated the accompanying drawings which are given hereinbelow by way of illustration only, and thus are not limitative of the present invention, and wherein:

FIG. 1 is a flowchart illustrating a surface treatment process of a metal separator for a fuel cell in accordance with an exemplary embodiment of the present invention.

FIG. 2 is a diagram showing a change in carbon bonding structure of an amorphous carbon film which occurred after heat treatment in accordance with an exemplary embodiment of the present invention.

FIG. 3 is a schematic diagram showing a typical separator.

FIG. 4 is a graph showing the measurement of interfacial contact resistance of metal separator samples according to Examples of the present invention.

FIG. 5 shows images of the surfaces of metal separators subjected to the surface treatment process of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

As known in the art, carbon is one of the most abundant elements on earth and serves to determine the boundary between organic substances and inorganic substances. The carbon belongs to group 4 in the periodic table and is a unique element having no electrons in its inner shell. Moreover, the carbon shows very different characteristics from those of silicon (Si), germanium (Ge), etc. which belong to the same group

That is, the carbon is a unique element of group 4, which exists in three boding states corresponding to sp³, sp², and sp hybridization of the atomic orbitals and has various physicochemical properties from fullerene (C⁶⁰) as an electrical superconductor to diamond as an insulator and from graphite with low hardness to diamond with super hardness according to the bonding structure.

The bonding of carbon atoms forms a graphite structure (100% sp² bonding) in the most thermodynamically stable state and forms a diamond structure (100% sp³ bonding) in a semi-stable state at high temperature and high pressure.

Amorphous carbon capable of being synthesized at room temperature due to its low synthesis temperature has a mixed structure of a graphite structure of sp² which provides electrical conductivity and a diamond structure of sp³ which provides insulating properties. Therefore, the amorphous carbon possesses physicochemical properties such as high hardness, which is similar to that of the diamond, excellent wear resistance, lubricating properties, electrical conductivity, chemical stability, and light permeability, and is formed from various hydrocarbons such as. CH₄, C₂H₂, and C₆H₆.

The amorphous carbon exhibits a significant difference in the electrical conductivity according to the proportion of sp³ and sp² and has a high specific resistance (i.e., contact resistance) of 10⁴ to 10¹⁴ Ωcm due to its electrical insulating properties.

Therefore, according to the present invention, the surface of the metal separator for the fuel cell is coated with amorphous carbon and subjected to heat treatment or laser beam irradiation to impart electrical conductivity, thus forming a conductive amorphous carbon film.

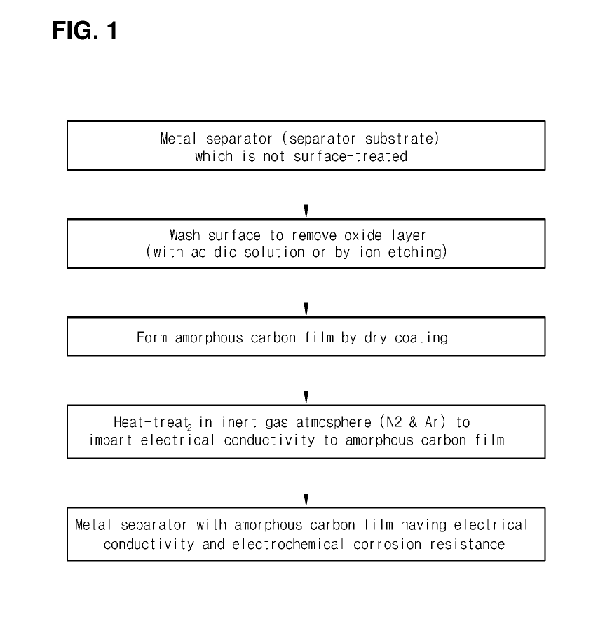

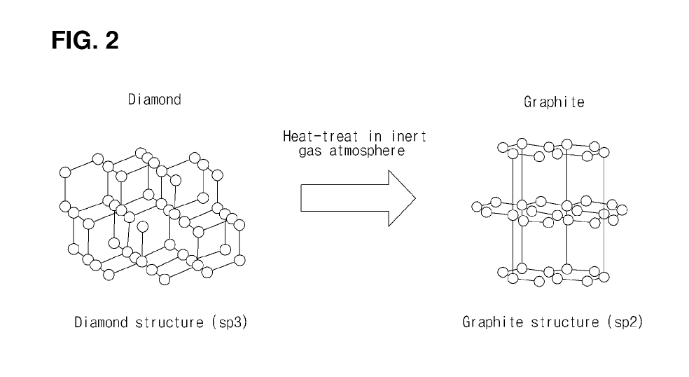

FIG. 1 is a flowchart illustrating a surface treatment process of a metal separator for a fuel cell in accordance with an exemplary embodiment of the present invention, and FIG. 2 is a diagram showing a change in carbon bonding structure of an amorphous carbon film before and after heat treatment in accordance with an exemplary embodiment of the present invention.

In order for the metal separator to satisfy the conditions required for a fuel cell separator, it is necessary to allow the metal separator to have high electrical conductivity and excellent electrochemical corrosion resistance. Since the electrochemical corrosion resistance of the amorphous carbon is excellent, the electrical conductivity of the amorphous carbon film is increased by the surface treatment method of the present invention.

For this purpose, as shown in FIG. 1, the surface of a metal separator (hereinafter referred to as a “separator substrate”), which has not been surface-treated, is washed to remove any oxide layer, and an amorphous carbon film (or a diamond phase carbon film) is formed on the separator substrate by dry coating. In this case, the surface of the separator substrate may be washed with an acidic solution or by ion etching for the removal of the oxide layer. Typically, the amorphous carbon film may be formed by dry coating using plasma enhanced chemical vapor deposition (PECVD), ion plating, sputtering, laser ablation, or filtered vacuum arc deposition.

In the RF-PECVD or the ion plating, a hydrocarbon gas such as methane (CH₄), acetylene (C₂H₂), or benzene (C₆H₆) is used, and in the sputtering, the laser ablation, or the filtered vacuum arc deposition, a solid carbon target is used.

In order to form a dense amorphous carbon film on the surface of the separator substrate, it is preferred that the carbon ions collide with the film growth surface (on the surface of the separator substrate on which the amorphous carbon
film is formed) with a bias voltage of 50 to 500 eV.

Next, as shown in FIG. 2, the diamond structure (SP³) mixed in the amorphous carbon film is converted to the graphite structure (SP²) to impart high electrical conductivity to the amorphous carbon film coated on the separator substrate.

For this purpose, the amorphous carbon film is heat-treated at a temperature of 500° C. or higher in an inert gas atmosphere of nitrogen (N₂) and argon (Ar).

At this time, the higher the heat treatment temperature, the higher the proportion of SP² in the amorphous carbon film, and thereby the amorphous carbon film has a high electrical conductivity. If the amorphous carbon film is heat-treated at a temperature below 500° C., it has no electrical conductivity.

As such, the amorphous carbon film having high electrical conductivity and excellent electrochemical corrosion resistance can be formed on the surface of the separator substrate by the heat treatment under the above-described conditions.

Since the amorphous carbon film is formed on the surface of the separator substrate in the form of an amorphous solid film, its thickness is restricted by high residual stress generated during the formation. Therefore, if it is formed with a thickness of at least several μm, it destroys by itself, although it depends on the formation method.

Therefore, in the present invention, the amorphous carbon film may be formed with a thickness of 2 μm or less by appropriately controlling the coating time and the bias voltage.

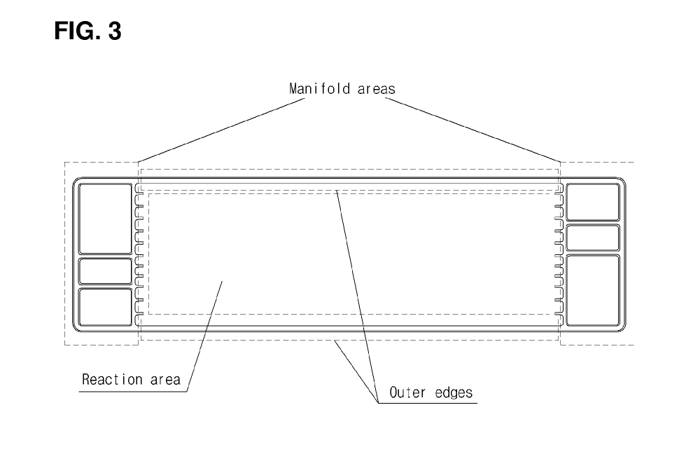

FIG. 3 is a schematic diagram showing a typical separator.

The conductivity of the amorphous carbon film formed on the separator substrate may be increased by laser beam irradiation besides the above-described heat treatment.

When the conductivity of the metal separator is increased by the heat treatment, the entire surface is carbonized and converted to a graphite structure. However, when the conductivity of the metal separator is increased by the laser beam irradiation, only a selected area of the metal separator, e.g., a reaction area of the metal separator in FIG. 3 may be converted to a graphite structure.

Moreover, when the conductivity of the metal separator is increased by the laser beam irradiation, it is possible to control the thickness of the amorphous carbon film by adjusting the irradiation time or the intensity of the laser beam.

The process of selectively irradiating the laser beam to the reaction area of the metal separator, which requires electrical conductivity, may be performed by any method known to those of ordinary skill in the art, and therefore a detailed description thereof will be omitted.

As such, when the conductivity is imparted to the amorphous carbon film using the laser beam, only the amorphous carbon film coated on the reaction area of the metal separator, which requires electrical conductivity, is carbonized and converted to a graphite structure, and the remaining areas such as manifold areas and outer edges of the metal separator have a diamond structure of the amorphous carbon film. Therefore, it is possible to selectively treat the surface of the metal separator for the fuel cell, and thus it is possible to increase both the performance and the durability.

The following examples illustrate the invention and are not intended to limit the same.

### EXAMPLES

The surfaces of separator substrates made of stainless steel (STS) were washed with a mixed solution of nitric acid and hydrochloric acid to remove any oxide layer of the separator substrates.

Next, an amorphous carbon film was formed on each of the separator substrates by PECVD, thus preparing six metal separator samples.

The samples were heat-treated at temperatures of 300° C., 400° C., 500° C., 550° C., 600° C., and 700° C., respectively, in an inert gas atmosphere of nitrogen and argon.

### Test Examples

Interfacial contact resistance of each of the metal separators heat-treated in the Examples was measured with respect to the compaction force applied thereto.

Moreover, the interfacial contact resistance of a separator substrate made of stainless steel (STS) and having no amorphous carbon film and that of a graphite separator were measured with respect to the compaction force applied thereto.

In general, the interfacial contact resistance is created between the separator and the GDL, and the separator having excellent interfacial contact resistance can transport the electrons generated at the anode to the cathode without loss. Therefore, if the interfacial contact resistance is reduced, it is possible to increase the electrical conductivity of the separator.

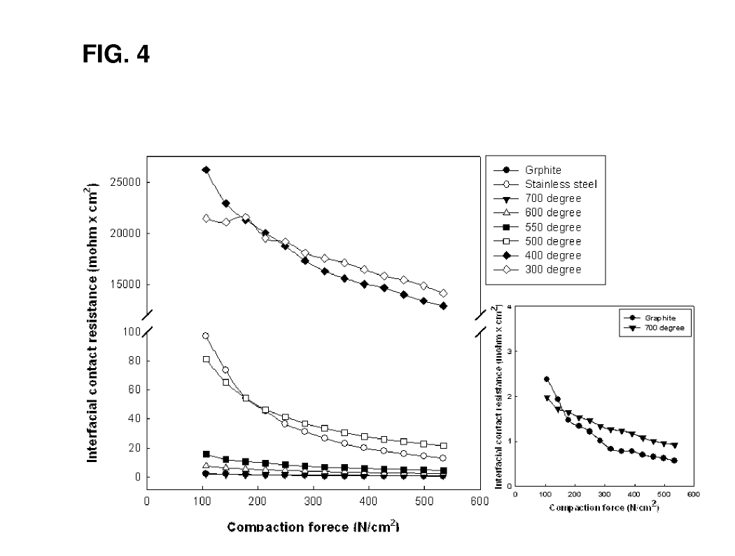

To this end, in the Test Examples of the present invention, the interfacial contact resistance of each of the metal separator samples, the graphite separator, and the separator substrate made of stainless steel (STS) was measured. The measurement results are shown in FIG. 4 and the quantitative measurement values are shown in the following table 1:

TABLE 1

| | Contact resistance |
|---|---|
| Sample name | (mΩ · cm²) at 150 N/cm² |
| Graphite separator | 1.472 |
| STS separator substrate | 54.368 |
| Sample heat-treated at 700° C. | 1.648 |
| Sample heat-treated at 650° C. | 5.464 |
| Sample heat-treated at 600° C. | 10.648 |
| Sample heat-treated at 500° C. | 54.448 |
| Sample heat-treated at 400° C. | 21337.15 |
| Sample heat-treated at 300° C. | 21597.15 |

As shown in FIG. 4, the metal separator sample heat-treated at 700° C. shows the same interfacial contact resistance as the graphite separator, the metal separator sample heat-treated at 550° C. shows an interfacial contact resistance of 10 mΩ·cm² or lower which is the minimum level required by the fuel cell separator, and the metal separator sample heat-treated at 500° C. shows the same interfacial contact resistance as the separator substrate made of stainless steel (STS).

Therefore, it can be seen that the heat treatment temperature of the metal separator to impart the conductivity to the amorphous carbon film is at least 500° C.

Moreover, the interfacial contact resistance is reduced when the heat treatment temperature of the metal separator is increased, and thus it can be seen that the proportion of SP² in the amorphous carbon film is increased.

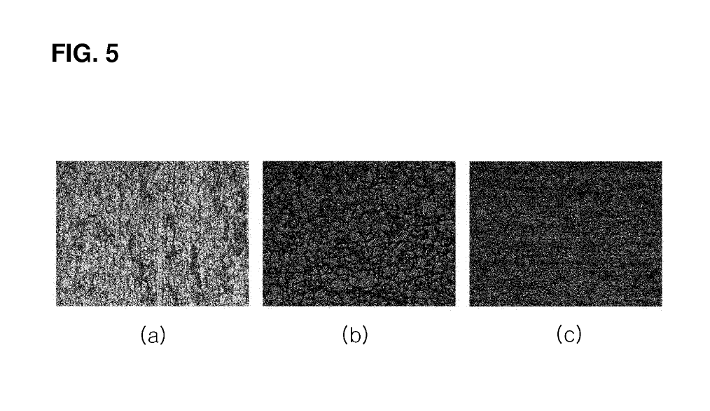

FIG. 5 shows images of the surfaces of metal separators subjected to the surface treatment process of the present invention, in which (a) shows the surface of the separator substrate, (b) shows the surface of the metal separator on which the amorphous carbon film is formed, and (c) shows the surface of the metal separator heat-treated at 600° C.

As described above, the present invention provides the metal separator for the fuel cell, in which the amorphous carbon film having excellent corrosion resistance and electrochemical corrosion resistance is formed on the surface of the separator substrate and the amorphous carbon film is heat-treated at a temperature of 500° C. or higher to have electrical conductivity required for the fuel cell separator.

Therefore, it is possible to increase the electrochemical corrosion resistance of the metal separator to prevent the formation of metal oxides in the metal separator and prevent the corrosion of the metal separator, thus improving the performance of the fuel cell.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for treating the surface of a metal separator for a fuel cell, the method comprising:
forming an amorphous carbon film on the surface of a separator substrate; and
carbonizing the amorphous carbon film by heat treatment to increase the proportion of sp², which allows the amorphous carbon film to have electrical conductivity.

2. The method of claim 1, wherein the heat treatment temperature of the amorphous carbon film is 500° C. or higher.

3. The method of claim 1, wherein the amorphous carbon film is formed to have a thickness of 2 μm or less.

4. The method of claim 1, wherein the amorphous carbon film is heat-treated in an inert gas atmosphere of nitrogen and argon.

5. A method for treating the surface of a metal separator for a fuel cell, the method comprising:
forming an amorphous carbon film on the surface of a separator substrate; and
carbonizing the amorphous carbon film by laser beam treatment to increase the proportion of sp², which allows the amorphous carbon film to have electrical conductivity.

6. The method of claim 5, wherein the amorphous carbon film is formed to have a thickness of 2 μm or less.
